(19) United States
(12) Patent Application Publication
(10) Pub. No.: US 2006/0155641 A1
(43) Pub. Date: Jul. 13, 2006

(54) Prepaid card with multiple depositors

(76) Inventor: Richard Postrel, Miami Beach, FL (US)

Correspondence Address: ANTHONY R. BARKUME, 20 GATEWAY LANE, MANORVILLE, NY, 11949, US

(21) Appl. No.: 11/314,946

(22) Filed: Dec. 21, 2005

Related U.S. Application Data
(60) Provisional application No. 60/638,223, filed on Dec. 21, 2004.

(51) Int. Cl. G06Q 40/00; G07F 19/00; G06K 5/00; G07D 11/00

(52) U.S. Cl. 705/39; 235/379; 235/380

(57) ABSTRACT

A user is provided with access to funds in an account held an account server computer, the account associated with and accessible via a token. A plurality of unique depositor identifiers is associated with the account, with of the depositor identifiers enabling a depositor to deposit a subset of funds into the account. Each subset of funds will be recorded in the account in association with the depositor identifier. Each of the depositor identifiers are subsequently distributed to a plurality of depositors. A depositor may then deposit a subset of funds into the account using the depositor identifiers he or she has been provided, with the subset of funds being recorded in the account in association with the depositor identifier. A user then may access funds from the account using the token, with the funds including at least one subset of funds previously deposited by a depositor. A statement of the account may be generated that indicates each subset of funds deposited by a depositor along with the identifying indicia (i.e. the depositor identifier or a depositor name previously associated with that depositor identifier) associated with the deposited subset of funds.

### CROSS-REFERENCE TO RELATED APPLICATIONS

This application is based on and claims filing priority of co-pending U.S. Provisional Application Ser. No. 60/638,223, filed on Dec. 21, 2004, entitled PREPAID CARD WITH MULTIPLE DEPOSITORS, which is incorporated by reference herein.

### BACKGROUND OF THE INVENTION

The present invention relates to a card such as a prepaid stored value card, a prepaid debit card, or a multi-function card incorporating various functions in addition to this invention, and in particular to a card that allows multiple parties to deposit value to the card.

The credit and debt card system is ubiquitous and well-entrenched in today's society. One of the drawbacks of this system is the requirement that a cardholder either have a credit account with a financial institution such as a bank (in the credit card scenario) or have a checking or savings account with a financial institution against which purchases are debited (in the debit card scenario). Many consumers are either unable or unwilling to use such credit or debit accounts in this manner.

As a result, a prepaid card industry has developed. Although there are several variants of the system, the basic premise is that a user may purchase a card for a certain amount of money, and then use that card to make purchases in a debit card fashion. For example, a consumer may purchase a $100 prepaid VISA card and use the card in any establishment that accepts VISA for payment. The prepaid card account will be drawn down until it is exhausted. This allows anyone to use the convenience of a credit card type of instrument without needing a credit account or even a bank account (such as in the traditional debit card scenario).

Some prepaid card systems are adapted as an adjunct to a regular credit card and targeted in particular to teenagers or college students. A credit card holder may obtain a prepaid card and give it to another person such as a teen family member, and the credit card holder may periodically transfer funds from his credit account into the prepaid card account. The family member may use the prepaid card as a credit card as described above, but will be precluded from spending more than what has already been transferred that account. The family member may also withdraw cash funds from an ATM if allowed by the bank. This is a convenient way for parents to provide money to their college students children while away from home without having to physically send them a check, deposit into their checking account, etc. In addition, some programs allow the main credit card holder to obtain a monthly statement of their child's spending on their prepaid card for oversight purposes. They also may be able to have some control over acceptable transactions before they occur, where they can either designate certain purchases that are disallowed (such as video games and liquor), or ones that are allowed (such as gasoline and food purchases).

Prepaid cards are available in two types of formats; a stored value card and an account card. An account card is simply a plastic card with a link to an account that exists on a server such as a bank computer, such as a card with a magnetic stripe that identifies the account. As well known in the art, when the user presents the card, it is swiped through a reader and the account information is used by the credit card network and infrastructure to execute the transaction. There is no information as the amount of value in the user's account on the card itself; it is just a link to the account held on another computer.

A stored value card does not necessarily link to an external account, but rather has the account “value” stored on the card itself. For example, a device known as a smart card has processing circuitry and memory embedded on the card, so that a user's account and value information may be stored and modified on the card by a smart card reader such as at a point of sale terminal (POS). A user may purchase a $100 card, and as he uses it the value on the card will be decreased accordingly. Other types of stored value card technologies may also be used to record and modify account information on the card itself, rather than on an external computer as previously described.

The present invention is an improvement on the present prepaid card system that allows multiple depositors into a single prepaid account wherein each depositor has access to depositing funds into the account but cannot obtain any information on the account, and wherein the user may obtain an accounting of the various depositors into the account.

### SUMMARY OF THE INVENTION

The present invention is a method and system for providing a card such as a stored value card, smart card, magnetic stripe card, etc. that is linked or contains to an account that enables multiple depositors to make deposits as desired to the account, wherein the prepaid card holder is given access to the various deposits while the individual depositors have no access to any other information regarding the account unless provided for in a rules profile.

Thus, the present invention is a method of and system for providing a user with access to funds, which includes but is not limited to cash (e.g. from a bank account), credit accessible via a credit based account, value of any kind, reward points, intangible privileges, items or services for bartering and the like, coupons or promotional currency, energy or pollution control credits, merchant or manufacturer product inventories, etc. Under this invention, and for example in a simple cash or credit based scenario, an account is established on an account server computer, the account being associated with and accessible via a token (such as a multifunction card). A plurality of unique depositor identifiers (such as but not limited to PINs) are associated with the account, with of the depositor identifiers enabling a depositor to deposit a subset of funds into the account. Each subset of funds will be recorded in the account in association with the depositor identifier.

Each of the depositor identifiers are subsequently distributed to a plurality of depositors (such as by email, regular mail, telephone call, instant message, etc.). A depositor may then deposit a subset of funds into the account using the depositor identifiers he or she has been provided, with the subset of funds being recorded in the account in association with the depositor identifier. A user then may access funds from the account using the token, with the funds including at least one subset of funds previously deposited by a depositor. A statement of the account may be generated that indicates each subset of funds deposited by a depositor along with the identifying indicia (i.e. the depositor identifier or a depositor name previously associated with that depositor identifier) associated with the deposited subset of funds. The statement may be accessible via a user computer interconnected to the account server computer via a wide area network such as the Internet.

In a scenario wherein the token is a card encoded with an identification of the account, the user may access funds from the account by presenting the token to a point of sale terminal during a purchase transaction for an item. The token is used by the point of sale terminal to determine the identification of the account, and the point of sale terminal communicates with a purchase authorization system using the identification of the account to obtain an authorization for the user to execute the purchase transaction. The purchase authorization system causes the account server computer to reduce the amount of funds in the account by the amount of the purchase transaction. This scenario acts in the same manner as a credit card or debit card transaction and may in fact use the same authorization methodologies and systems as a credit or debit based transaction (i.e. it may piggy-back the credit card system).

In another scenario in which the token is a card encoded with an identification of the account, the user may access funds from the account by presenting the token to a cash dispensing terminal (such as an ATM) with a request to withdraw funds from the account. The token is used by the cash dispensing terminal to determine the identification of the account, and the cash dispensing terminal communicates with a cash dispensing authorization system using the identification of the account to obtain an authorization for the user to withdraw the requested funds from the account. The purchase authorization system causes the account server computer to reduce the amount of funds in the account by the amount of the requested cash withdrawal. This scenario acts in the same manner as a cash withdrawal transaction from an ATM and may in fact use the same authorization methodologies and systems as an ATM based transaction (i.e. it may piggy-back the ATM system).

A depositor may deposit a subset of funds into the account by using a depositor computer to communicate with the account server computer over a wide area network. The depositor provides via the depositor computer to the account server computer the depositor identifier and an identification of a source of depositor funds from which the account server computer will obtain the subset of funds being deposited into the account by the depositor. The account server computer then may interact with the source of depositor funds in order to obtain the subset of funds and deposit said subset of funds into the account. For example, the source of depositor funds may be a bank account or a credit account.

### BRIEF DESCRIPTION OF THE DRAWING

FIG. 1 illustrates a block diagram of the present invention.

FIG. 2 illustrates an account statement rendered by the card issuer in accordance with the present invention.

### DETAILED DESCRIPTION OF THE PREFERRED EMBODIMENT

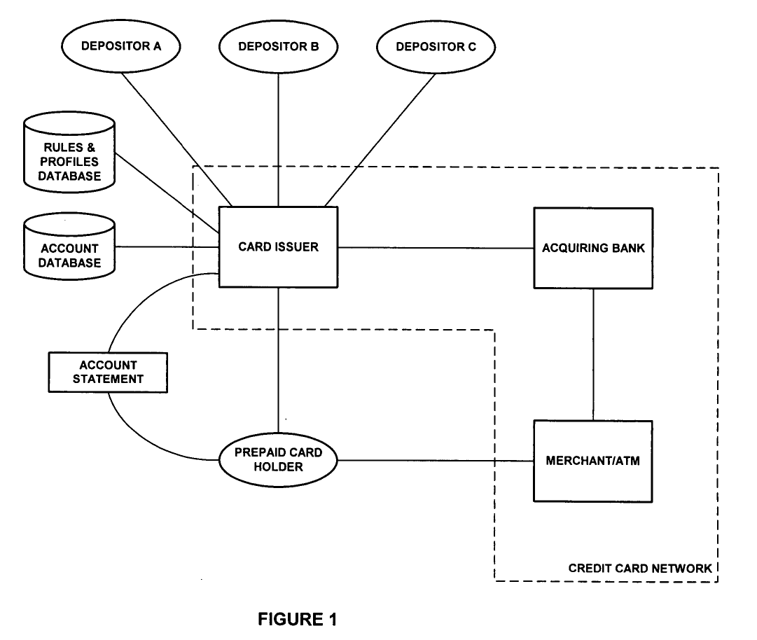

FIG. 1 illustrates the present invention with respect to a token such as a prepaid card that has a magnetic stripe linked to an account stored in an account server associated with a prepaid card issuer. The card issuer issues a prepaid card that is acquired by a user, for example in a retail outlet, by ordering over the Internet or phone, etc. The prepaid card may be initially activated and loaded with an initial amount, for example $50, but preactivation and loading is not required. Activation may occur at the point of sale, over the telephone, via the Internet, etc. as known in the art. The card holder is able to provide deposit information to third parties, shown as Depositor A, Depositor B, and Depositor C, as follows.

Each Depositor will be provided with the account number or other identifying indicia of the prepaid card, which in this example is account number 12345678. Each Depositor may also be given a unique depositor identifier such as a PIN or access number that he will use to make the desired deposit. The PIN may be determined in various ways. In one embodiment, PINs are generated by the card issuer and provided to the card holder. They may be provided in a written statement, email, via Internet access of a web site for the issuer, over the telephone, etc. In any event, the card holder will have a series of PINs that he can associate with and distribute to the desired Depositors. For example, he may simply tell Depositor A his PIN, and then tell Depositor B his PIN, etc. The system may also require the user to request a new PIN as desired, rather than giving them to the card holder in batch format. PINs may have a limited lifespan, such as one month, which would require the card holder to distribute a new PIN to a Depositor once the old PIN has expired.

Once a Depositor has its PIN, it can proceed to make a deposit of a subset of funds into the prepaid card account. This may be done in one or more of several manners. For example, the Depositor may log onto a web site operated by the card issuer, where he may enter his PIN (he may also need to enter the card holder's account number) and indicate a payment. The payment may be made by credit card, debit card, etc., similar to any type of purchase of a product over the Internet. A transaction fee may be charged to the Depositor and/or the card holder for this service. The Depositor may also make deposits via terminals such as existing ATMs modified to operate in accordance with this invention. Once payment has been made, the account is credited with the appropriate amount and that subset of funds is available to be used by the card holder. There may be a deposit notification mechanism employed, such as email to the account holder informing him of the deposit amount, or a text message or phone call, etc.

Deposits may be made into the account on an automatic or periodic basis. For example, a depositor may specify that he would like a $250 deposit to be made, funded by his credit card, at the end of each month. This would continue for a specified number of payments, or until a specified date is reached, or indefinitely until modified by the depositor. This may be referred to as an automatic reload function.

Optionally, there may be a mechanism employed for storing an identifying indicia of the Depositor along with the PIN he has been assigned. For example, the Depositor's name may be associated with the PIN. This may be done by the cardholder or such as via a web site entry, for example when the card holder obtains the PIN. He would enter the Depositor's name and the card issuer would store the Depositor's name with the PIN. In this case, the deposit notification could also have the name of the Depositor as follows:

“John Smith has just deposited $500 to your card account 12345678”

In the alternative, the Depositor may only have a PIN and he may be able to enter his name or other identifier into the system.

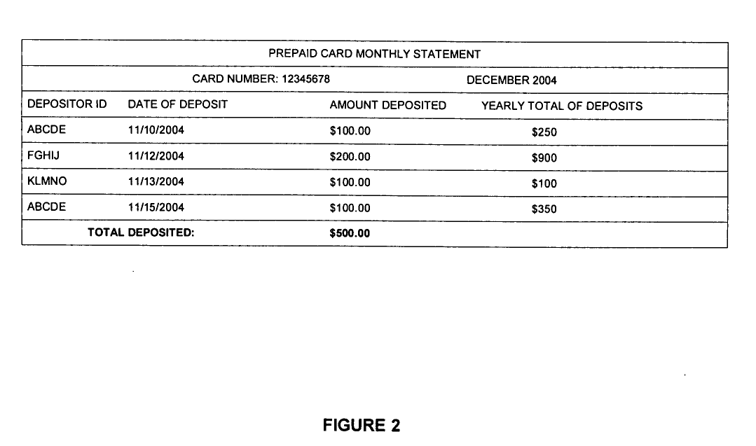

In addition, a statement is issued periodically, such as on a monthly basis, as shown in FIG. 2. The account statement would show a list of all deposits made, give the name and/or name of the Depositor, etc. This allows the user to easily see who has made deposits and it what amounts and when the deposits were made. The statement may be mailed to the user, emailed to the user, or made accessible via a web site, etc.

As a result of the present invention, the card holder has easy access to deposits made by a number of persons, and can easily determine who has given him funds and in which amounts. The Depositors do not have access to other depositors' records, so one depositor can't find out how much another depositor has given the card holder. Many applications for this technology exist, such as in a business context. For example, an attorney could open a prepaid card account and distribute a PIN to each of his clients. The client could easily make payment whenever desired by using the preassigned PIN as described above. Thus, the attorney could collect funds into his account and have records of which client has made timely payments, etc. The prepaid card could be linked to their accounts held by the attorney, such as a savings and checking account, so that the attorney could transfer funds as desired after they have been deposited.

Other businesses that may rely on cash transactions will also greatly benefit from this invention. For example, a landscaper or gardener might set up a card under this invention and distribute PINs to each customer, requesting that they make payment into their respective PIN as bills become payable. Other occupations such as independent sales contractors, waiters, and the like are also benefited accordingly.

Another application would be a gift service. A user would obtain the card, perhaps as a birthday or wedding gift. The user would then obtain and distribute PINs as described above to persons wishing to provide a gift. Each person could then make a gift deposit to the user's card, and the user would know which person gave him which amounts, etc. as described above.

This invention also has applicability in the area of direct deposit, where an employer is given a PIN and can deposit an employee's paycheck into the account as described herein. Governmental agencies can be provided with a PIN, such as for social security deposits and disability payment deposits.

Automatic bill payment mechanisms may also be employed with the present invention.

FIG. 1 illustrates how the prepaid gift card is used in a credit card environment in the same manner as any other credit card. After the card account has been funded, the user may present the card just as a credit card to a merchant or point of sale terminal, who would use the purchase authorization system of the credit card network (the acquiring bank and card issuer) to ascertain if the transaction should be approved and the prepaid card should be debited accordingly (funds reduced in the user account), as known in the art. Wired and wireless networks may be used in this invention.

The user may also access funds via a terminal such as an ATM, which may be an existing ATM modified (if so required) in accordance with this invention. For example, one application of this invention provides for a user to have a card that may be used to access funds from an ATM, wherein the funds are available from deposits made by various depositors in accordance with this invention. This would allow a user in a country different from the depositor(s) to be provided with easy access to cash funds from an ATM as soon as they are deposited by the various depositors as described above.

In a further embodiment, a Depositor may be able to impose certain rules (as shown in rules database in FIG. 1) that govern how funds are utilized by the card holder. For example, a Depositor may only want the card holder to use the funds that Depositor has deposited for food and clothing, and not for video games and liquor. Rules can be entered into the system, for example over a web site link, that will allow the Depositor to impose such conditions. In that event, a given transaction may be disallowed, for example if the card holder tries to purchase an XBOX console for $150 and such purchase would require use of funds that have been earmarked for food only. The card issuer would then not allow the transaction to proceed when queried by the merchant acquiring bank as part of the transaction.

In addition to depositing cash into the prepaid card account, other items of value may be transferred such as reward points. A Depositor may be able to exchange reward points that he has in one of his reward point accounts into a reward account associated with the prepaid card. Thus, Depositor A could deposit 1,000 reward points from an airline account, Depositor B could deposit 500 reward points from his credit card reward account, etc. An exchange rate may be used to determine how many exchange reward points are then credited to the card holder's account. For example, the card holder may end up with 1,300 total exchange points in a reward account linked to the prepaid card.

The present invention may also be used in conjunction with a stored value card such as a smart card wherein the account value(s) are stored in processing circuitry on the card itself rather than in a server-based account as described above. In this embodiment, a temporary account may exist for the purpose of allowing depositors to make deposits as described above. The deposit amounts will be stored temporarily (in one account or several individual accounts) until such time that the user presents his smart card to the system, typically by entering it into a reading terminal such as a at a POS. At that time, the deposited values temporarily held in the system will be transferred to the smart card so that the card holds al of the deposited values. The user may then use the card known in the art.

In the prior art, stored value cards are usually not linked to a specific user, and therefore they may be used by anyone who presets the card to a merchant. This provides for a very low level of security since the card is essentially the same as cash. Under the present invention, the stored value card is linked to a specific user and therefore the user may request that the card be voided in the event that it is lost or misplaced. A new card may be issued in its place and be usable instead of the original card.

The stored value card of the present invention may also be linked to special offers such that the user of the card is provided with access to thee offers by using the card as described herein.

Tokens other than prepaid cards may also be used with this invention. For example, a multifunction card or smart card may be adopted to include the functionality of the present invention in addition to other functions, such as credit card functions, debit card functions, and the like, as well known in the art. In addition, this invention may be used without a physical token, wherein the user may simply enter an account number in order to gain access to the account (e.g. over the Internet, at an ATM, via the telephone, at a POS terminal, etc.)

As described, the funds that the depositors deposit into the account (and that are used by the user) will typically be of a monetary value such as cash or credit, but may also include non-monetary value such as reward points, intangible privileges (e.g. privileges in using a country club), subscription services (e.g. rights to obtaining a massage, emission or energy credits), coupons, vouchers, and anything having any type of value.

What is claimed is:

1. A method of providing a user with access to funds comprising the steps of:
a. establishing an account on an account server computer, said account being associated with and accessible via a token;
b. associating a plurality of unique depositor identifiers with said account, each of said depositor identifiers enabling a depositor to deposit a subset of funds into said account, wherein said subset of funds are recorded in said account in association with said depositor identifier;
c. distributing each of said depositor identifiers to a plurality of depositors;
d. at least one depositor depositing a subset of funds into said account using one of said depositor identifiers, said subset of funds being recorded in said account in association with said depositor identifier;
e. a user accessing funds from said account using said token, said funds comprising at least one subset of funds deposited by a depositor.

2. The method of claim 1 further comprising the step of:
f. generating a statement of said account, said statement indicating each subset of funds deposited by a depositor along with identifying indicia associated with said deposited subset of funds.

3. The method of claim 2 wherein said identifying indicia comprises the depositor identifier associated with the subset of funds deposited into the account.

4. The method of claim 2 wherein the depositor accesses an identification record associated with the depositor identifier and enters a depositor name in association with the depositor identifier, and wherein said identifying indicia comprises the depositor name associated with the identifier associated with the subset of funds deposited into the account.

5. The method of claim 2 wherein said statement is accessible via a user computer interconnected to the account server computer via a wide area network.

6. The method of claim 1 wherein the token is a card encoded with an identification of the account, and wherein the step of the user accessing funds from said account using said token comprises:
i. the user presenting the token to a point of sale terminal during a purchase transaction for an item,
ii. the token being used by the point of sale terminal to determine the identification of the account,
iii. the point of sale terminal communicating with a purchase authorization system using the identification of the account to obtain an authorization for the user to execute the purchase transaction, and
iv. the purchase authorization system causing the account server computer to reduce the amount of funds in the account by the amount of the purchase transaction.

7. The method of claim 1 wherein the token is a card encoded with an identification of the account, and wherein the step of the user accessing funds from said account using said token comprises:
i. the user presenting the token to a cash dispensing terminal with a request to withdraw funds from the account,
ii. the token being used by the cash dispensing terminal to determine the identification of the account,
iii. the cash dispensing terminal communicating with a cash dispensing authorization system using the identification of the account to obtain an authorization for the user to withdraw the requested funds from the account, and
iv. the purchase authorization system causing the account server computer to reduce the amount of funds in the account by the amount of the requested cash withdrawal.

8. The method of claim 1 wherein the step of at least one depositor depositing a subset of funds into said account using one of said depositor identifiers, said subset of funds being recorded in said account in association with said depositor identifier, comprises:
i. the depositor using a depositor computer to communicate with the account server computer over a wide area network;
ii. the depositor providing via the depositor computer to the account server computer the depositor identifier and an identification of a source of depositor funds from which the account server computer will obtain the subset of funds being deposited into the account by the depositor;
iii. the account server computer interacting with the source of depositor funds in order to obtain the subset of funds and deposit said subset of funds into the account.

9. The method of claim 8 wherein said source of depositor funds is a bank account.

10. The method of claim 8 wherein said source of depositor funds is a credit account.

11. The method of claim 1 further comprising the step of notifying the user that the depositor has deposited a subset of funds into the account.

12. The method of claim 1 wherein the plurality of unique depositor identifiers comprise a PIN.

13. The method of claim 1 wherein the plurality of unique depositor identifiers comprise a biometric identifier.

14. The method of claim 13 wherein the biometric identifier is a fingerprint pattern.

15. The method of claim 1 wherein the plurality of unique depositor identifiers comprise a unique access code.

16. The method of claim 1 wherein said funds comprise cash held in a bank account.

17. The method of claim 1 wherein said funds comprise credit accessible via a credit based account.

18. The method of claim 1 wherein said funds comprise non-cash value.

19. The method of claim 1 wherein said funds comprise reward points,

20. The method of claim 1 wherein said funds comprise intangible privileges.

21. The method of claim 20 wherein said intangible privileges comprise access rights to a restricted access organization.

22. The method of claim 1 further comprising the step of allowing each of said depositors to ascertain information regarding the user accessing funds associated with that particular depositor.

23. The method of claim 1 further comprising the step of allowing each of said depositors to establish rules regarding a manner in which the user may access the funds associated with that particular depositor.

24. The method of claim 1 in which funds deposited by said depositors are a donation, and in which said user is a charitable entity.

25. The method of claim 1 which is carried out in association with a computer network.

26. The method of claim 1 which is carried out in association with an interactive television system.
